(19) United States
(12) Patent Application Publication
(10) Pub. No.: US 2005/0219956 A1
(43) Pub. Date: Oct. 6, 2005

(54) Method and apparatus to track rest time during a fitness exercise

(76) Inventor: Vladimir Gershman, Holland, PA (US)

Correspondence Address: VLADIMIR GERSHMAN, 3476 COVENTRY PLACE, HOLLAND, PA, 18966, US

(21) Appl. No.: 10/708,898

(22) Filed: Mar. 30, 2004

(51) Int. Cl. G04F 8/00

(52) U.S. Cl. 368/110

(57) ABSTRACT

Device in the present invention is a rest timer is that is easy to use and can be mounted on a frame of a weight lifting equipment. The device comprises four preset buttons, which set commonly used rest times. The time is displayed on LCD display. Pressing a button starts the rest time countdown. After the countdown reaches zero an audio signal sounds and the display shows the preset value again. The rest value can be adjusted by using up/down buttons. The device uses a microprocessor to control LCD display, timing and buttons. This allows for a very low component count and ease of manufacturing. User-friendly buttons layout makes the device suitable to use by any level or skill fitness club participant. The device is powered by a battery and can last a long time thanks to power-saving logic of a computer program running on the microprocessor.

### BACKGROUND OF INVENTION

1. Field of Invention

This invention relates to the field of monitoring a fitness exercise.

2. Description of Prior Art

Rest is important part of a fitness exercise. Proper rest period between each exercise set promotes better muscle recovery and makes the exercise enjoyable. There is a number of fitness monitoring devices, but very few address the issue of rest time properly.

Some devices, like the one described in a U.S. Pat. No. 4,632,570 provide a complicated scheme of interval training, which is not suitable for an average fitness enthusiast. Other devices, such as the one described in U.S. Pat. No. 6,547,434 do not provide a complete user interface such as a visual display. Also, per '434 the device has to be owned by a user, which means purchased and carried around. This is inconvenient by the fact that anything one has to bring to the gym has to be stored somehow or has to be removed when doing certain exercises, etc.

Even most of the electrical fitness equipment available on the market does not explicitly address issue of rest between sets of exercise.

An average gym club participant needs a rest-monitoring device that is easy and convenient to use. If the device is presented to the user by a fitness club, the user does not have to worry about loosing or breaking the device, which is not the case with devices that have to be brought in. To outfit the fitness club with such a device, the device must be easy to install into the existing gym equipment without any equipment modification or redesign. To our knowledge, such a device currently is not available.

### SUMMARY OF INVENTION

Device in the present invention is a rest timer that is easy to use and can be mounted on a frame of a weightlifting equipment. The device consists of four preset buttons, which set commonly used rest times. The time is displayed on LCD display. The rest time is counted down when a START button is pressed down. After the countdown reaches zero an audio signal sounds and the display shows the preset value again. The rest value can be adjusted by using up/down buttons. The device uses a microprocessor to control LCD display, timing and buttons. This allows for a very low component count and ease of manufacturing. Small button count and easy to use panel layout make the device suitable for use by any level or skill fitness club participant. The device is powered by a battery and can last a long time thanks to power-saving logic of a computer program running on the microprocessor.

### BRIEF DESCRIPTION OF DRAWINGS

FIG. 1 is a block diagram of the rest timer unit.

FIG. 2 is a simplified electrical block diagram.

FIG. 3 is simplified flowchart describing operation of the logic of a program running on the microprocessor.

### DETAILED DESCRIPTION

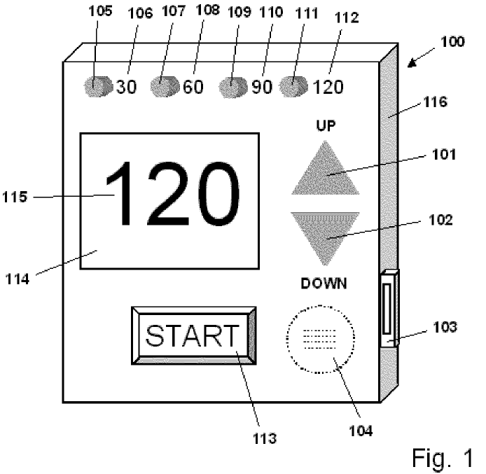

As shown in FIG. 1, the device 100 is powered by a battery, which is inserted using a battery holder 103. When any of the preset buttons 105, 107, 109, or 111 are pressed down once, the display 114 shows a corresponding countdown value 115. The preset buttons 105, 107, 109, or 111 have next to them a label with a value of a popular preset rest time 106, 108, 110, or 112. The label can be put on by such methods as silk-screening, engraving or any other methods. Once one of the preset buttons 105, 107, 109, or 111 has been pressed down and the corresponding value 115 is displayed on LCD 114, pushing START button 113 will begin the countdown. Once the countdown reaches zero, an audio signal will be generated thru a speaker 104. After sounding the audio signal, the display 114 will show the original rest value 115. Buttons 101 or 102 can be used to change the preset value to whatever custom value the user desires. Pressing down buttons 101 or 102 will increment or decrement display by 1 second respectively. The value will become a new default and will be displayed after the countdown is over. The device is housed into a low height enclosure 116. The device is lightweight and can be mounted onto a frame of existing gym equipment with Velcro glued to the back of the device or a strap.

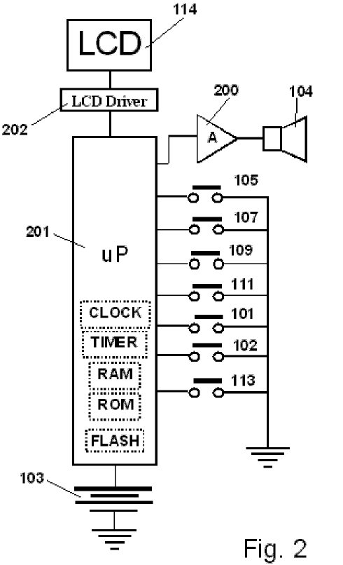

FIG. 2 shows a simplified block diagram of electronic design. Microprocessor 201 handles all logic and controls of the device, including LCD 114, LCD driver 202 and buttons 105, 107, 109, 111, 101, 102 and 113. The microprocessor 201 is a modern IC, such as PIC from Microchip Technology, that contains internal ROM memory to hold a program, internal RAM memory for data, internal clock to strobe the program instructions, internal timer to calculate time, and internal FLASH memory to store data. A battery in the battery holder 103 powers the device. An amplifier 200 is used to drive the speaker 104.

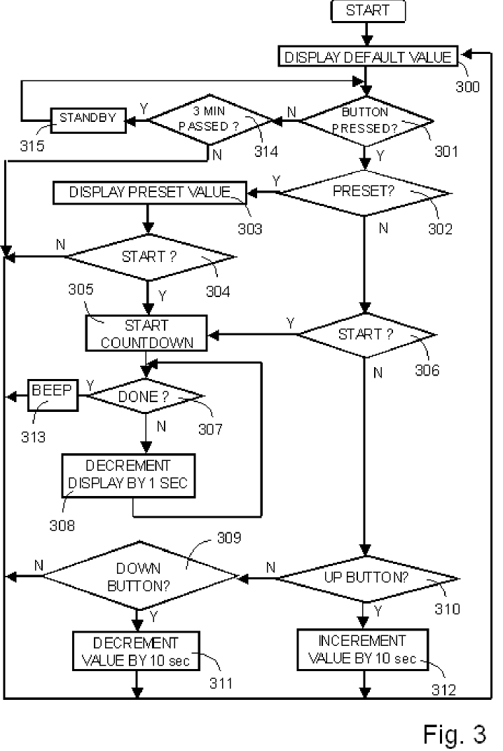

FIG. 3 describes simplified logic of the program running on the microprocessor 201. The program starts in step 300 by displaying a default value. The default value could be either a value entered through preset buttons 105, 107, 109, 111 or up/down buttons 101/102. In the step 301, the program waits for a button to pressed down. If decision block 301 determines that no buttons have been pressed, it goes to decision block 314. If no buttons have been pressed for more than 3 minutes, the program puts the micrcontroller 201 into a standby mode 315 to conserve battery energy. If decision block 302 determines that, the button is a preset button 105, 107, 109, 111, then, in step 303, the value corresponding to the preset button used is displayed. If the output of the decision block 304 is false for the START button, the program returns back to 300; otherwise, it starts countdown in step 305. If the countdown reaches zero, as checked by decision block 307, speaker 104 is activated and audio signal is generated as shown in step 313. The type of audio signal can be of various kinds and is not relevant to the description of the invention. If the countdown is not over, the display value 115 is decremented by 1 second as shown in step 308.

If the output of decision block 302 was not the preset button, the program checks for the START button in decision block 306. If decision block 306 outputs true for the START button the program control goes to step 305 and proceeds as described above. If decision block 306 outputs false for the START button, the program checks whether it was up or down buttons 101/102 in decisions blocks 309 or 310. If the up/down buttons were detected, the display is incremented/decremented by 1 and program control returns to step 300, where the program sequence described above begins again. It is understood by those skilled in the field of software design that such standard software design functions as error checking, debouncing, driving of LCD segments, and count acceleration with prolonged button pressing, are assumed to be implemented, but are not mentioned for the sake of clarity.

1. A method and apparatus to track rest time during a fitness exercise and comprising:
LCD display with a driver,
Preset buttons,
Up/down increment/decrement buttons,
Audio device,
An enclosure,
A battery holder,
A battery,
A microprocessor,
A program executing on the microprocessor.

2. A method and apparatus in claim 1 where a program executing on the said microprocessor comprises functions:
To count down from 999 seconds to zero,
To countdown and display the value in decrements of 1 second
To display the rest time during countdown and set up
To generate audio signal upon countdown completion
To control all buttons, LCD, and initiate standby mode

3. A method and apparatus in claim 1, where a user-friendly interface layout for set up and viewing is used comprising:
Large LCD digits
Buttons with preset popular rest times to allow one button set up
Ability to set custom rest time
Easy battery replacement
Automatic resets to a default at the end of countdown after audio alarm
Start at default value
Keeping the unit continuously ready with no need for a power switch

4. A method and apparatus in claim 1, where the device is easy to mount on existing equipment using Velcro, epoxy or magnetized backing

5. A method and apparatus in claim 1, where buttons with presetpopular rest times allow one button set up and quick start

6. A method and apparatus in claim 1, where energy saving is done using standby mode and low power microprocessor and LCD display

7. A method and apparatus in claim 1, where labeling on the panel is used for preset buttons.

8. A method and apparatus in claim 1 where a single microprocessor comprising internal ROM, RAM and flash memories, internal clock and timers is used to control all external input/outputs.

9. A method and apparatus in claim 1, where no power switch is used and the unit is always on.
